(19) United States
(12) Patent Application Publication
(10) Pub. No.: US 2006/0070271 A1
(43) Pub. Date: Apr. 6, 2006

(54) Monthly planner

(76) Inventors: Sammy Ting, Toronto (CA); Chi T. Chan, Hong Kong (CN)

Correspondence Address: BIRCH STEWART KOLASCH & BIRCH, PO BOX 747, FALLS CHURCH, VA, 22040-0747, US

(21) Appl. No.: 11/242,777

(22) Filed: Oct. 5, 2005

(30) Foreign Application Priority Data
Oct. 5, 2004 (CA) 2,483,841

(51) Int. Cl. G09D 3/00

(52) U.S. Cl. 40/107

(57) ABSTRACT

A monthly planner comprises two or three grids each representing a separate month. The grids are blank and are completed by writing in months that they represent and the days of the months. Information relating to tasks to be carried out or activities occurring during the months may be written in the appropriate days in the grids. The grids are arranged on a sheet of plastic or cardboard and are held in position by retainers. The retainers are constructed so that the order of the grids can be rearranged.

### FIELD OF THE INVENTION

This invention relates to a method of displaying information relating to tasks to be carried out or activities occurring over a given period of time. More particularly the invention relates to a method by which information pertaining to tasks or activities occurring over a period of at least two months is entered only once, and once entered need not be copied or re-entered again over the two month period. The invention also relates to a monthly planner for displaying such information.

### BACKGROUND OF THE INVENTION

Monthly planners which are presently available on the market display a grid which represents a given month in a year. There are seven columns in the grid, each headed by the name of the day of a week and five rows, each representing a separate week in a month. Typical of such a grid is the first grid illustrated in FIG. 1.

In use, a user records, at the top of the grid, the name of the month and, in the top left corner of each block which makes up the grid, the days which fall in that month. The second grid in FIG. 1 illustrates a calendar filled out in this way for the month of September of 2003.

The blank spaces in each block in the grid may be filled in with information such as the activities scheduled for that month and tasks to be completed.

A conventional monthly planner may display more than one month on a single sheet of plastic or cardboard. The surface of the sheet is such that information may be recorded on it using an erasable ink. A felt marker is usually used for this purpose. The information may then be later removed leaving no trace of what was previously recorded. The monthly planner of FIG. 2, for example, displays three months, labeled September, October and November of 2003 written in erasable ink. Activities or tasks scheduled for those three months are then entered in the months by means of the marker.

At the end of each month, a user removes all the information from the grid for that month and transfers the information for the next month onto the grid for the month then ended.

By way of example, and with reference first to FIG. 3, at the end of September, the user would remove all the information from the upper grid 3a. Then and with reference to FIG. 4, the user would transfer all the information entered for the month of October, i.e. the middle grid 4b, onto the upper grid 4a where the activities for September were previously recorded.

The user would then erase all in information from the middle grid 5b as illustrated in FIG. 5, and copy the information set out in the calendar for November, i.e. the lower grid 5c, onto the middle grid 5b where the activities for October were previously recorded as illustrated in FIG. 6. The activities recorded in the lower grid 6c would then be erased as illustrated in FIG. 7 and that space would be used to record the activities scheduled for the month of December as illustrated in FIG. 8.

Conventional monthly planners such as the one just described have a number of shortcomings one of which being the undue amount of time and care which are required to properly record the information. At the end of each month, the information on each grid must be erased and the information from the next month must be transferred to that grid. Such a task is both laborious and time-consuming.

A second shortcoming of conventional monthly planners is that they open the door to errors. If there is a mistake in the order of erasing and transferring information from one grid to another, information may be lost that cannot be recovered. For example if the information from the month of October is accidently erased at the same time as the information is erased for the month of September, the information for October may be irrecoverable. Similarly, if there is a mistake in the transferring of information from one grid to another, information may be lost and cannot be recovered.

### SUMMARY OF THE INVENTION

These and other shortcomings of conventional monthly planners are eliminated in the monthly planner of the subject invention. Briefly the subject monthly planner comprises: at least two grids each having a network of lines which define a plurality of blocks arranged in columns and rows. Each column has an indication of a separate day of the week and each block has a surface which lacks permanent indicia of a day of the month but upon which a day of the month can be removably written. The monthly planner also includes a retainer adapted to removably display the grids in juxtaposition.

### DESCRIPTION OF THE DRAWINGS

The monthly planner of the subject invention is described with reference to the accompanying drawings in which:

FIG. 1 illustrates two grids of a conventional monthly planner set out on a sheet;

FIGS. 2-8 illustrate three grids of a conventional monthly planner;

FIG. 9 illustrates three blank grids of the subject invention set out on a sheet

FIGS. 10 and 11 illustrates three completed grids;

FIG. 12 illustrates two completed grids and one in blank; and

FIG. 13 illustrates two completed grids and one partially completed;

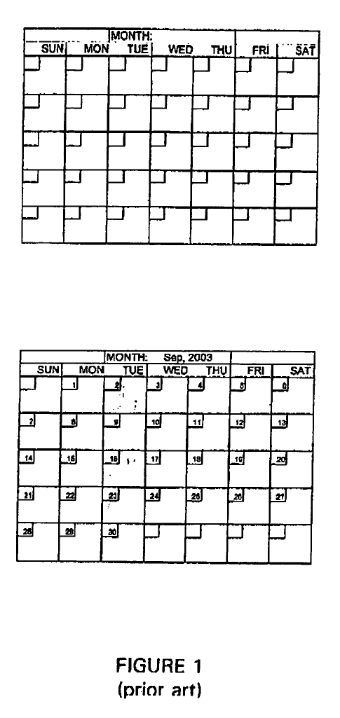

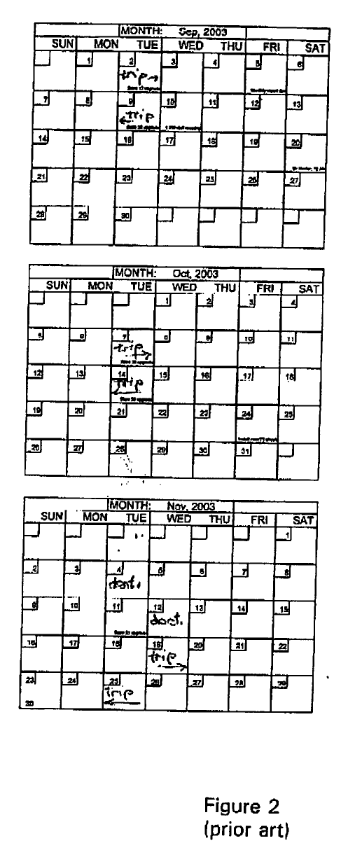

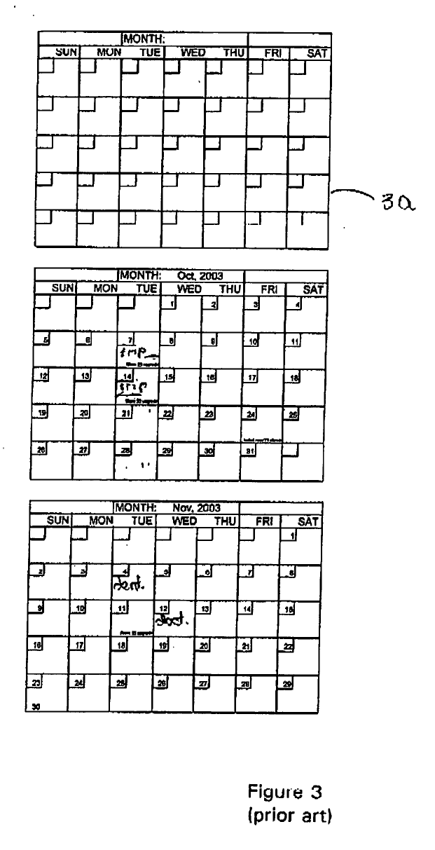

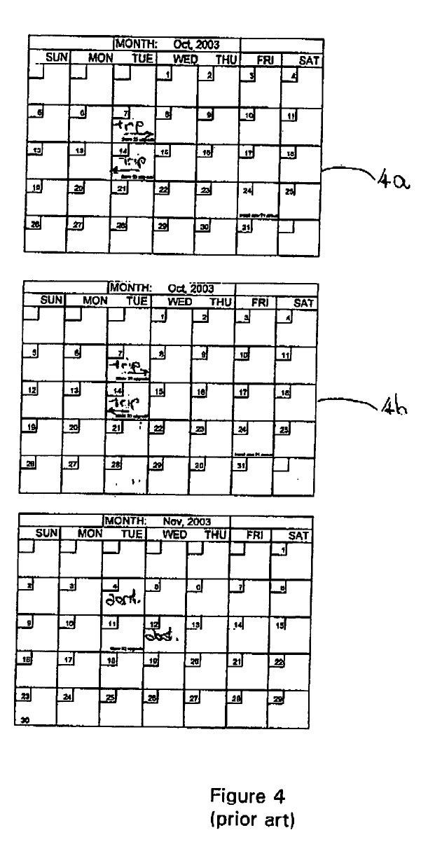

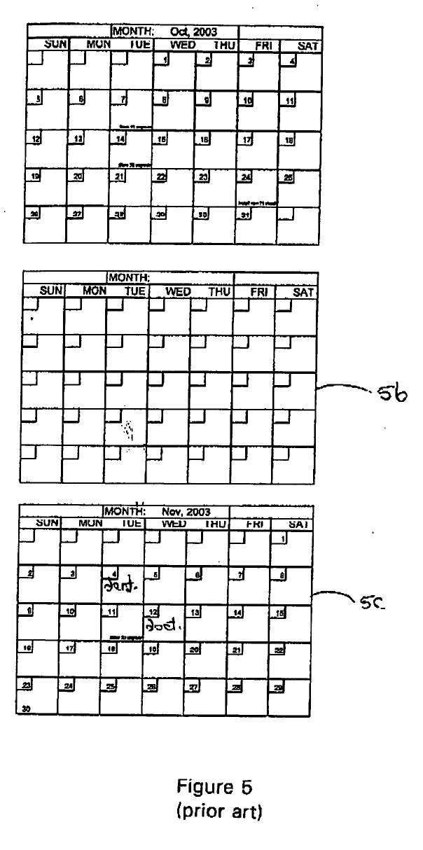

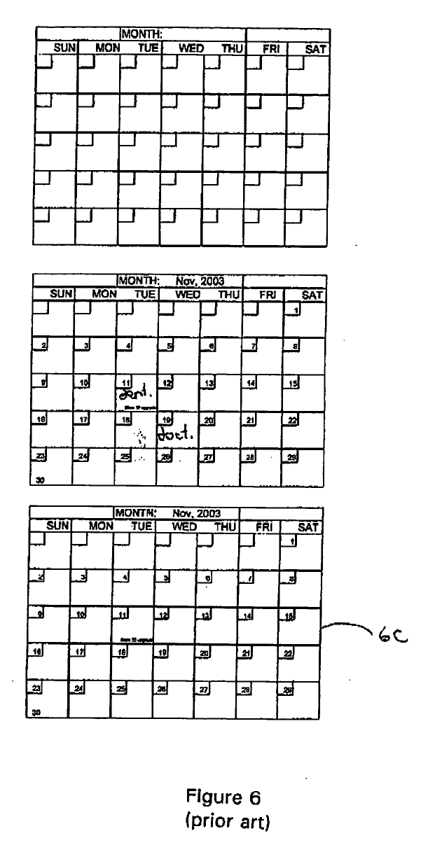

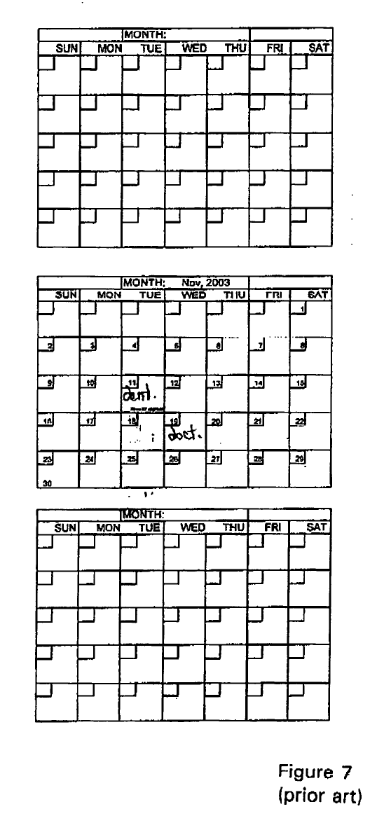

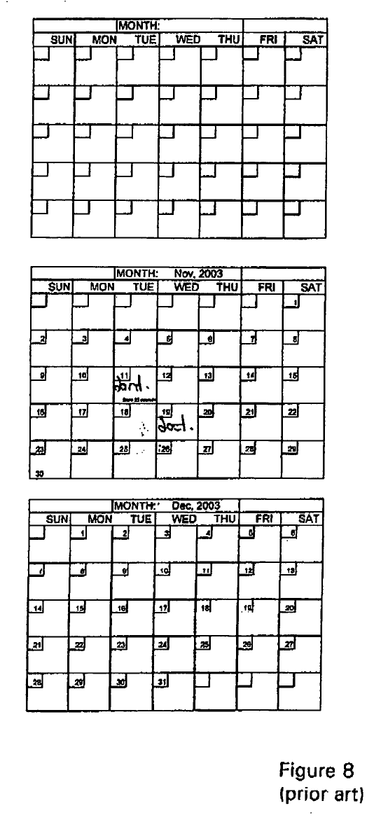

### DESCRIPTION OF PREFERRED EMBODIMENT

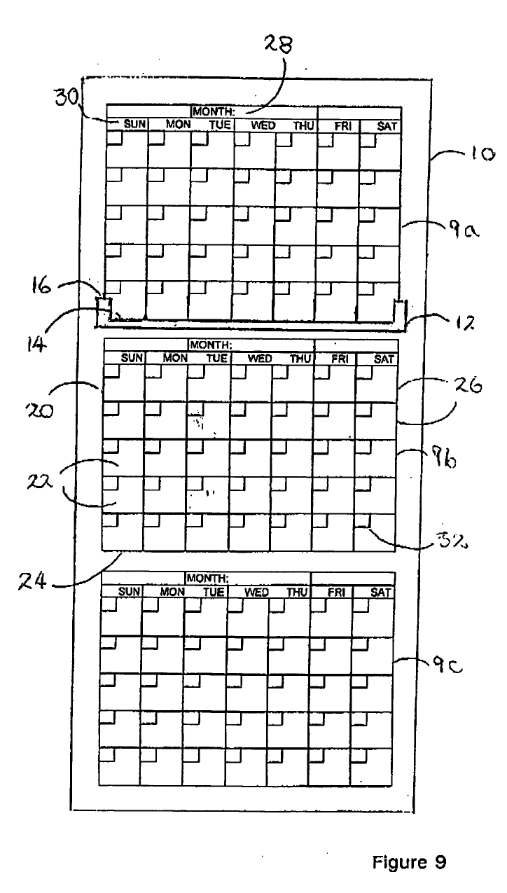

With reference to FIG. 9, the monthly planner consists of three grids, a first grid 9a, a second grid 9b and a third grid 9c. The grids which are arranged on a sheet 10 of plastic, cardboard or the like. Each grid is held in position by a U-shaped retainer 12 having a lower wall 14 and two side walls 16. The side walls extend upwardly from opposite ends of the lower wall and in each side wall as well as the lower wall there is a groove for removable receipt of one grid. The retainer thus removably displays the grids in juxtaposition on the sheet and makes it possible to remove a grid from one retainer and re-position it in either of the two other retainers on the sheet.

Each grid has a network of lines 20 which define a plurality of blocks 22 arranged in seven horizontally spaced columns 24, and five vertically spaced rows 26. There is a space 28 at the top of each grid for the name of a month and a space 30 at the top of each column for the day of the week.

Within each block there is a smaller block 32 for the date of the month. The date must not be permanently entered in the block since the grid must be usable for any month of the year. Accordingly, block 32 is blank so that any number can be written in it.

The surface of sheet 10 on which the grids appear is such that information may be recorded on it using erasable ink. The ink may be contained in a felt marker or other form of marker. The information may then be later removed leaving no trace of what was previously recorded.

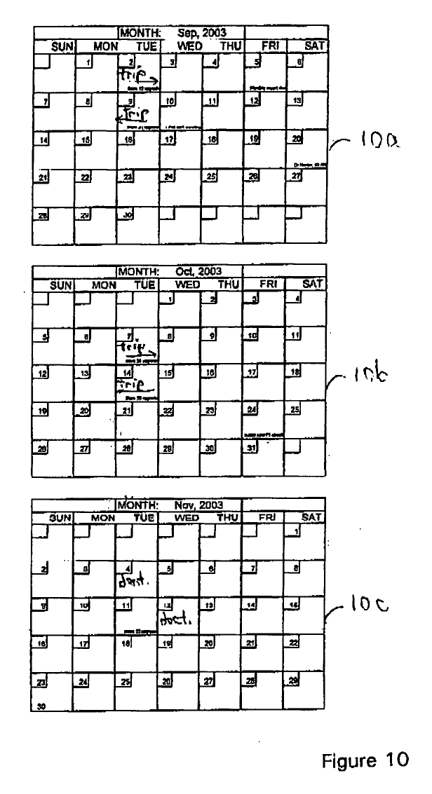

The monthly planner of the subject invention is used in the following manner. With reference first to FIG. 10, at the beginning of the month that the monthly planner is to be first used, the name of that month is written at the top of the first grid 10a and the names of the next two months are written at the top of the next two grids 10b and 10c. Assuming that the monthly planner is to be first used in September 2003, grid 10a is headed, “September 2003”, and the next two are headed “October 2003” and “November 2003”.

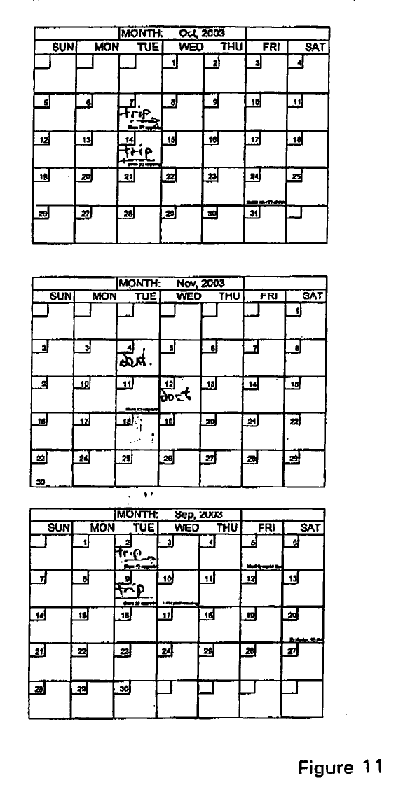

At the end of September, grid 10a is removed from the retainer and is replaced by grid 10b. Similarly grid 10c is removed from its retainer and is placed where grid 10b was previously and grid 10a is placed where grid 10c was previously, as illustrated in FIG. 11.

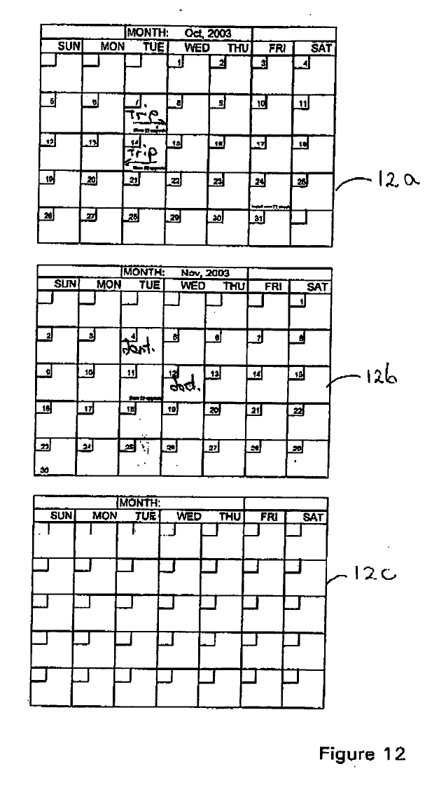

All information in grid 12c is then erased as illustrated in FIG. 12.

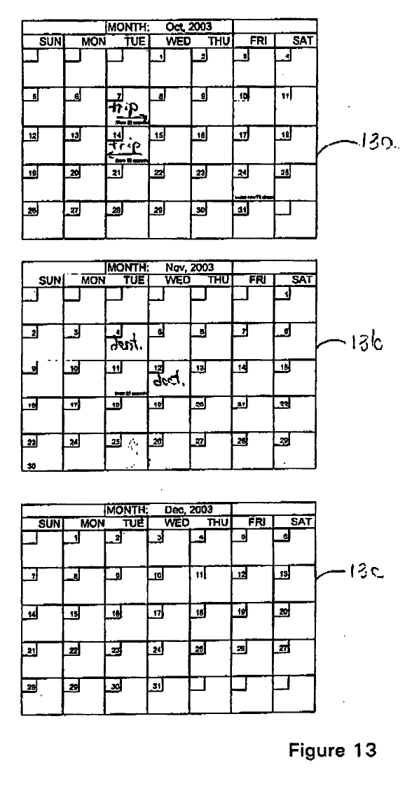

As illustrated in FIG. 13, a new heading, namely “December 2003” is inserted at the top of grid 13c and the dates of that month are inserted in the blocks in the grid. Information pertaining to that month is then entered in the grid as and when the information becomes available

It will thus be understood that information pertaining to activities and tasks need be entered only once in the subject monthly planner. Information need not be transferred from one grid to another at the end of a month unlike the conventional monthly planner described above. Accordingly no time need be spent in copying information from one grid to another and no copying errors can occur.

It will be understood, of course, that modification can occur in the monthly planner that is illustrated and described herein without departing from the scope and purview of the invention as defined in the appended claims. For example, means other than retainer 12 of FIG. 9 may be used to removably attach the grids to sheet 10. The fastener identified by the trade-mark VELCRO is suitable for removably attaching the grids to the sheet as are many other well known fasteners.

We claim:

1. A monthly planner comprising: at least two grids each having a network of lines which define a plurality of blocks arranged in columns and rows, each said column having an indication of a separate day of the week and each said block having a surface but upon which a day of the month can be removably written; and a retainer adapted to removably display said grids in juxtaposition, said retainer being arranged and constructed such that the order of said grids can be rearranged.

2. A method of displaying information relating to tasks to be carried out or activities occurring over a period of two months comprising the steps of:
(i) providing first and second grids each having a network of lines which define a plurality of blocks arranged in columns and rows, each said column having an indication of a separate day of the week and each said block having a surface upon which a day of the month can be removably written;
(ii) writing on said first grid the name of the current month, and the second said grid, the name of the next month in succession;
(iii) writing in horizontally consecutive blocks of each grid, consecutive number such that the numbers in the columns in the grid for each month represent the days of that month which fall on the day of the week indicated for each column;
(iv) at the end of the current month; rearranging the grids such that the second grid is first in succession followed by the first grid; and
(v) erasing the writing on the first grid and writing in horizontally consecutive blocks of the so-erased first grid consecutive number such that the numbers in the columns in the first grid represent the days of the month which fall in the second month after the current month.

3. A method of displaying information relating to tasks to be carried out or activities occurring over a period of three months comprising the steps of:
(i) providing first, second and third grids each having a network of lines which define a plurality of blocks arranged in columns and rows, each said column having an indication of a separate day of the week and each said block having a surface upon which a day of the month can be removably written;
(ii) writing on the first said grid the name of the current month and on the second said grid the name of the next month in success and on the third said grid the name of the month two months in succession;
(iii) writing in horizontally consecutive blocks of each said grid consecutive number such that the numbers in the columns in the grid for each month represent the days of that month which fall on the day of the week indicated for the columns;
(iv) at the end of the current month; rearranging said grids such that the second grid is first in succession, the third grid is next in succession and the first grid is last in succession;
(v) erasing the writing on the first grid and writing in horizontally consecutive blocks of the so-rased first grid consecutive number such that the numbers in the columns in the so-erased first grid represent the days of the month which fall in the third month after the current month.

4. A method of displaying information relating to tasks to be carried out or activities occurring over a period of two months comprising the steps of:
(i) providing first and second grids each having a network of lines which define a plurality of blocks arranged in columns and rows, each said column having an indication of a separate day of the week and each said block having a surface upon which information can be removably written;
(ii) writing on said first grid means for identifying the current month and on the second grid means for identifying the next month in succession;
(iii) writing in the blocks of the first said grid numbers which indicate the days of the current month such that the days are referred to the days of the week of the current month and writing in the blocks of the second said grid numbers which indicate the days of the next month such that the days are referred to the days of the week of the next month;
(iv) at the end of the current month; rearranging said grids such that the second grid is first in succession followed by the first grid;
(v) erasing the writing on the first grid and writing on the first grid means for identifying the the month two months ahead of said current month; and
(vi) writing in the blocks of said first grid numbers which indicate the days numbers which indicate the days of the month two months ahead of the current month such that the days are referred to the days of the week of the second month ahead of the current month.

5. A method of displaying information relating to tasks to be carried out or activities occurring over a given period of time over a period of three months comprising the steps of:
(i) providing first, second and third grids each having a network of lines which define a plurality of blocks arranged in columns and rows, each said column having an indication of a separate day of the week and each said block having a surface upon which information can be removably written;
(ii) writing on said first grid means for identifying the current month and on the second grid means for identifying the second month in succession and on the third grid means for identifying the third month in succession;
(iii) writing in the blocks of the first grid numbers which indicate the days of the current month such that the days are referred to the days of the week of the current month and writing in the blocks of the second grid numbers which indicate the days of the second month such that the days are referred to the days of the week of the second month and writing in the blocks of the third grid numbers which indicate the days of the third month such that the days are referred to the days of the week of the third month;
(iv) at the end of the current month; rearranging said grids such that the second grid is first in succession followed by the third grid and ending with the first grid;
(v) erasing the writing on the first grid and writing on the first grid means for identifying the the month three months ahead of said current month; and
(vi) writing in the blocks of the first grid numbers which indicate the days of the month three months ahead of the current month such that the days are referred to the days of the week of the month in the third month ahead of the current month.
